(19) United States
(12) Patent Application Publication
(10) Pub. No.: US 2023/0263333 A1
(43) Pub. Date: Aug. 24, 2023

(54) BEVERAGE PREPARATION MACHINE

(71) Applicant: SOCIETE DES PRODUITS NESTLE S.A., Vevey (CH)

(72) Inventors: ALEXANDRE PUGLIESE, Paudex (CH); ALEXANDRE PERENTES, Sullens (CH); XAVIER RICHI, Morges (CH); LUCIO SCORRANO, Yverdon-les-Bains (CH)

(21) Appl. No.: 18/005,267

(22) PCT Filed: Jul. 13, 2021
(86) PCT No.: PCT/EP2021/069388

§ 371 Date: Jan. 12, 2023

(30) Foreign Application Priority Data
Jul. 15, 2020 (EP) 20185901.4

(51) Int. Cl. A47J 31/46

(52) U.S. Cl. CPC A47J 31/461; A47J 31/60

(57) ABSTRACT

The invention relates to a beverage preparation machine (100), which comprises a beverage production device (200) having a cavity (222) for receiving a beverage component to prepare a beverage upon interaction with a liquid, a liquid delivery device (300) for delivering a liquid into the cavity (222) via a liquid inlet (320), and a liquid discharge device (400) for discharging the delivered liquid out of the cavity (222) via a discharge outlet (420) and to a dispensing outlet (470). The liquid discharge device (400) comprises a flexible tube (450) provided between the discharge outlet (420) and the dispensing outlet (470). The beverage preparation machine (100) further comprises a deforming device (500) configured to selectively deform the flexible tube (450) so as to restrict or prevent a liquid flow from the cavity (222) to the dispensing outlet (470). Further, the invention relates to a method for delivering a liquid through a beverage preparation machine (100).

### FIELD OF THE INVENTION

The present invention relates to a beverage preparation machine and a method for delivering a liquid through a beverage preparation machine.

### TECHNICAL BACKGROUND

Beverage preparation machines having a beverage preparation device with a removeable capsule holder are known in the prior art. These machines are commonly used for on demand dispensing of beverages, like coffee, tea or hot chocolate. Such beverage preparation machines are convenient as the user can simply select a beverage of their liking and consume the beverage immediately afterwards.

Commonly, the capsule containing a beverage component is inserted in the capsule holder of the beverage preparation machine, the capsule holder is closed and the beverage preparation is started. Liquid, such as water or milk, is delivered to the capsule to interact with the beverage component inside the capsule in order to produce the desired beverage. Then the prepared liquid leaves the capsule and is dispensed in a cup.

It is referred in the present application to a capsule to designate a closed receptable, pod or cartridge that may enclose a food or beverage ingredient or nutrient. Any type of capsule design may be conceived according to the design of the capsule holder. The capsule may have a rigid housing or not. It may be made of any material compatible with its function, like recyclable, biodegradable or compostable material.

However, consumers demand a high variety of flavours and different types of drinks, which requires that the liquid flows through the capsule with different flow rates or remains inside the capsule for different time intervals.

Also, consumers are looking more often for appliances that are versatile to allow them to dispense not only beverages but also viscous food products, such as soups. Thus, the beverage or the food product may contain fibers or may have a relatively high viscosity, which increases the risk of pipes or tubes being blocked inside the beverage preparation machine. Moreover, the different fluids may have varying acidities that may lead to corrosion or material deterioration. Unfortunately, these conditions mean that commonly used valves, like ball valves, piston valves or gate valves, are not suitable.

In addition, it has to be avoided that residues remain in the machine to avoid bacterial growth but also unpleasant flavouring or contamination of subsequently prepared food products. Thus, sufficient and frequent cleaning and sanitization of the machine is required. This may require implementing new sophisticated cleaning methods that go beyond rinsing of the machine with water after a food or beverage preparation cycle. Moreover, the fluid path of the liquid should not be blocked by protruding parts of a control valve.

Also, the liquid delivery path must be closed reliably to ensure hygiene of the machine.

Therefore, it is an object of the present invention to provide a method for delivering a liquid through a beverage preparation machine and a beverage preparation machine, which overcome the afore-mentioned drawbacks. Thus, it is an object of the present invention to provide a beverage preparation machine that allows precise control of the flowrate of the liquid flowing through the capsule. Also, blockages of the beverage preparation machine should be avoided and frequently changing viscosities or acidity in the beverage preparation machine should not limit its lifespan.

These and other objects, which become apparent upon reading the description, are solved by the subject matter of the independent claims. The dependent claims refer to preferred embodiments of the invention.

### SUMMARY OF THE INVENTION

A first aspect of the invention relates to a beverage preparation machine.

The beverage preparation machine comprises a beverage production device, which has a cavity for receiving a beverage component to prepare a beverage upon interaction with a liquid. For example, the beverage component may be carried in a capsule.

The expression “interaction with a liquid” may be understood as any kind of chemical and/or physical reaction between the beverage component and the liquid, such as infusion, extraction or dissolution of the beverage component by means of the liquid, or any other kind of corresponding interaction to produce a beverage product.

Furthermore, the beverage preparation machine comprises a liquid delivery device for delivering a liquid into the cavity via (through) a liquid inlet.

Also, the beverage preparation machine comprises a liquid discharge device for discharging the delivered liquid out of the cavity via (through) a discharge outlet and to (and through) a dispensing outlet. For example, the delivered liquid may be (upon interaction with the beverage component) the prepared beverage.

The liquid discharge device comprises a flexible tube that is provided between the discharge outlet and the dispensing outlet.

The beverage preparation machine further comprises a deforming device that is configured to selectively deform the flexible tube so as to restrict or prevent a liquid flow from the cavity to the dispensing outlet.

In other words, the beverage preparation machine of the present invention is provided with a beverage production device, in which the beverage may be produced by dispensing a liquid into a cavity, in which the user may place a beverage component that may, for example, be carried by a capsule. Therefore, the beverage preparation machine comprises a liquid delivery device that delivers the liquid through a liquid inlet into the cavity. The liquid can leave the cavity through a discharge outlet of a liquid discharge device that is provided in the beverage preparation machine. The liquid released from the cavity is delivered to a dispensing outlet. Between the discharge outlet and the dispensing outlet a flexible tube is provided. By providing the beverage preparation machine with a deforming device that is configured to selectively deform the flexible tube, liquid can be restricted or prevented from flowing from the cavity to the dispensing outlet.

Thereby, it is possible to control the flow of the liquid. Deforming selectively (i.e. intentionally) the flexible tube allows flow control with high accuracy and reliability. Moreover, the control of the liquid flow can be accomplished without having to redirect or insert a control element into the liquid. Thereby, the risk of blockages in the fluid path of the liquid can be reduced and the hygiene and taste of the prepared beverages can be improved. Also, the control of the flow rate can be accomplished without having to consider the viscosity and composition of the delivered fluid. In addition, the flexible tube is easy to clean and to replace so that the hygiene of the beverage preparation machine can be improved. Moreover, the liquid path can be sealed off reliably from the outside of the dispensing outlet. Also, the number of parts of the beverage preparation machine can be reduced, thereby reducing manufacturing costs and the complexity of the design. In addition, in case of a component failure in the deforming device the flexible tube does not need to be removed and the fluid path of the liquid is not contaminated. Thus, hygiene can be improved even during maintenance work.

According to a preferred embodiment, the deforming device may comprise a support for carrying the flexible tube. Preferably, the support may be a rigid support.

Thereby, it is possible to protect the flexible tube from the outside, for example from accidental damaging during the assembly as direct contact with the flexible tube is no longer required. Moreover, the flexible tube is supported such that the flexible tube remains securely fixed and in place when being deformed by the deforming device.

According to a further preferred embodiment, the deforming device may comprise a pinching element. The pinching element may be moveable between a first position and a second position.

In the first position, the pinching element may deform the flexible tube so as to restrict or prevent the liquid flow from the cavity to the dispensing outlet.

In the second position, the pinching element may relax the flexible tube so as to allow increased liquid flow from the cavity to the dispensing outlet with respect to the first position.

The expression “restricting or preventing liquid flow” may be understood as shutting the flexible tube entirely off or at least limit the flow rate to a defined amount.

The expression “increased liquid flow” may be understood as the liquid flowing through the flexible tube being able to achieve the maximum flow rate or at least a flow rate that is higher or (noticeably) different than any flow rate achievable in the first position.

Thereby, it is possible to use the deforming device as a valve having at least two defined positions, such as an open and a closed position. Thus, the control of the deforming device can be simplified. In addition, it can be achieved that the element providing the deforming functionality does not come into contact with the contents of the flexible tube but remains outside. Thus, hygiene and product flow can be improved.

According to a preferred embodiment, the pinching element may comprise two pinching sections. Preferably, the pinching sections may be provided at opposite sides of the flexible tube. At least one of the pinching sections may be moveable (preferably with respect to the flexible tube) so as to selectively displace the pinching element between the first position and the second position. Also, one of the pinching sections may be moveable and the other one of the pinching sections may be fixed, whereby the latter preferably may be a part of the support like an inner side wall.

Thereby, it is possible to provide the deforming device with a structure that facilitates binary and linear control of the deformation amount of the flexible tube. Thus, the control accuracy and sealing capability of the beverage preparation machine can be improved. Also, it is possible to simplify the design and the assembly of the deforming device. In particular, the number of components can be reduced so that the requirements for maintenance and the risk of component failure decrease.

According to a further preferred embodiment, the flexible tube may comprise an abutting section for supporting the deforming device upon deformation action. Preferably, the abutting section may be a thickened wall section of the flexible tube for supporting the deforming device upon deformation action.

Thereby, it is possible to increase the lifespan of the flexible tube as the section of the tube being in contact with the deforming device has a higher material strength and thus, is more durable. In addition, it can be avoided that the deforming device accidentally pierces the flexible tube. Also, the abutting section may define the shape of the reduced flow path in the flexible tube and thus, improve the control capabilities of the beverage preparation machine. Further, the flexible tube may assist in assembling the beverage preparation machine as it provides an orientation aid.

According to a preferred embodiment, the deforming device may further comprise an actuator, like an electric motor, for actuating the deforming device. Preferably, the actuator may move the pinching element between the first position and the second position. Therefore, the actuator preferably may be functionally connected to the pinching element by way of a gear mechanism.

The expression of “being functionally connected” may be understood as being connected in a way that facilitates the intended functionality between the elements that are to be connected. Thus, for example, the actuator may not be connected directly with the pinching element but may be connected in the sense that torque generated by the actuator is in a way transmitted to the pinching element. The relationship between the two elements may thus be purely functional, for example.

Thereby, it is possible to automate the operation of the deforming device and to control the liquid flow with high accuracy and flexibility.

According to a further preferred embodiment, the beverage preparation machine may further comprise a gas evacuation device for evacuating gas out of the cavity. The gas may be air, for example. Preferably, the gas evacuation device may evacuate the gas from the cavity via a gas outlet. Preferably, gas may be evacuated upon beverage production or liquid delivery into the cavity and/or the capsule (if provided).

Thereby, trapped air inside the cavity or capsule can be removed and the liquid can spread more evenly inside the cavity or capsule. Also, the pressure in the cavity or capsule can be controlled and/or reduced. For example, some beverages, such as espresso, require a high pressure during the beverage preparation to achieve the desired result. On the other hand, tea may develop its full flavour best if the water wets the leaves slowly. Thus, the quality of the beverages can be improved while also improving the safety and operability of the beverage preparation machine.

According to a preferred embodiment, the liquid inlet and/or the discharge outlet may protrude into and/or taper towards the cavity to form a piercing tip. Additionally or alternatively, the gas outlet may protrude into and/or taper towards the cavity to form a piercing tip.

Thereby, the beverage preparation machine is provided with a structure that facilitates automatic preparation of a beverage without the user having to individually connect the machine to the cavity or capsule. Also, the product safety and hygiene is improved as the operator can recognise capsules that have already been inserted due to their piercing marks.

According to a further preferred embodiment, the liquid inlet and, if present, the gas outlet may be positioned higher than the discharge outlet.

Thereby, it can be achieved that gas is evacuated via the gas outlet efficiently. Also, with this configuration regarding the relative positions of the individual openings towards the cavity, it can be ensured that only gas leaves through the gas outlet and the liquid leaves through the discharge outlet.

According to a preferred embodiment, the beverage production device may comprise a removable part that comprises the cavity. Additionally, the beverage production device may comprise a receiving section for functionally receiving the removable part. Also, the cavity may be configured to receive a capsule carrying a beverage component to interact with a liquid delivered into the cavity by the liquid delivery device.

The expression of “functionally receiving” may be understood as an element being attached to another element such that the arrangement of the elements facilitates the functionality of at least one of the elements.

Thereby, it is possible to provide a structure that allows the user to merely place a capsule in the removable part and place the removable part inside the receiving part without having to orient the removable part in a particular manner. Thereby, operating the beverage preparation machine is simplified and its lifespan can be improved as the user is less prone to operating errors, such as misaligning the two parts.

According to a preferred embodiment, the beverage preparation machine may comprise a main body carrying the beverage production device, the liquid delivery device, the liquid discharge device, the deforming device, and/or, if present, the gas evacuation device.

Thereby, the beverage preparation machine can be provided as a single piece of machinery, which facilitates transport and operation of the appliance.

According to a further preferred embodiment, the deforming device may be detachably mounted. Preferably, the deforming device may comprise a connection section for connecting the deforming device to the main body. The connection section preferably may be integrally formed with the flexible tube.

Thereby, it is possible to improve the maintainability of the beverage preparation machine. In particular, the deforming device and the flexible tube are frequently used and subjected to wear. Thus, detachably providing the deforming device and the flexible tube together improves future maintenance work.

According to a preferred embodiment, the flexible tube may be substantially vertical when the beverage production device is in its production configuration. The discharge outlet may be substantially horizontal when the beverage production device is in its production configuration.

Thereby, the flow path of the liquid can be improved. Moreover, the control of the fluid flow can be improved as the discharge outlet may form a buffer zone that allows to delay the fluid stream (sufficiently long) so that the deforming device has additional time to respond to a control request for deforming or relaxing the flexible tube. This may be, for example, the time required to shut the flexible tube entirely when starting from an open position.

A second aspect of the invention relates to a method for delivering a liquid through a beverage preparation machine. The method comprises the steps of:
providing a beverage preparation machine as described for the first aspect of the invention;
optionally receiving a beverage component in the cavity of the beverage production device (for example, the beverage component may be carried in a capsule);
deforming the flexible tube with (by) the deforming device;
delivering a liquid by the liquid delivery device into the cavity via the liquid inlet, while preferably halting the deformation for a predetermined time;
releasing the flexible tube by the deforming device so as to discharge the delivered liquid out of the cavity via the discharge outlet to the dispensing outlet of the liquid discharge device.

The expression of “predetermined time” may be understood as a time interval that may have been decided or arranged at an earlier time, for example by the user setting the time or by selecting a program.

Thereby, the same advantages can be achieved as with the beverage preparation machine according to the first aspect of the invention. In particular, it is possible to deliver a liquid through a beverage preparation machine with an improved hygienic standard, better product quality and improved flow rate accuracy while reducing the need for frequent maintenance and unblocking repairs.

### BRIEF DESCRIPTION OF DRAWINGS

Further features, advantages and objects of the present invention will become apparent for the skilled person when reading the following detailed description of embodiments of the present invention and when taking in conjunction with the figures of the enclosed drawings.

In case numerals have been omitted from a figure, for example for reasons of clarity, the corresponding features may still be present in the figure.

FIG. 1 shows a schematic view of a beverage preparation machine according to an embodiment of the invention.

FIG. 2 shows a detailed view of the circled section in FIG. 1 having the reference I.

FIG. 3 shows a schematic view of a cross-section of a part of the beverage preparation machine of FIG. 1.

FIG. 4 shows a perspective view of an embodiment of the deforming device according to the present invention.

FIG. 5 shows a perspective view of components of the beverage preparation machine from FIG. 1.

FIG. 6 shows a perspective sectional view of the components in FIG. 5.

FIG. 7 show a perspective view of the flexible tube of the beverage preparation machine from FIG. 1.

### DETAILED DESCRIPTION

The figures show different views of an embodiment of the beverage preparation machine 100 according to the present invention. The beverage preparation machine 100 may be configured for preparing food products.

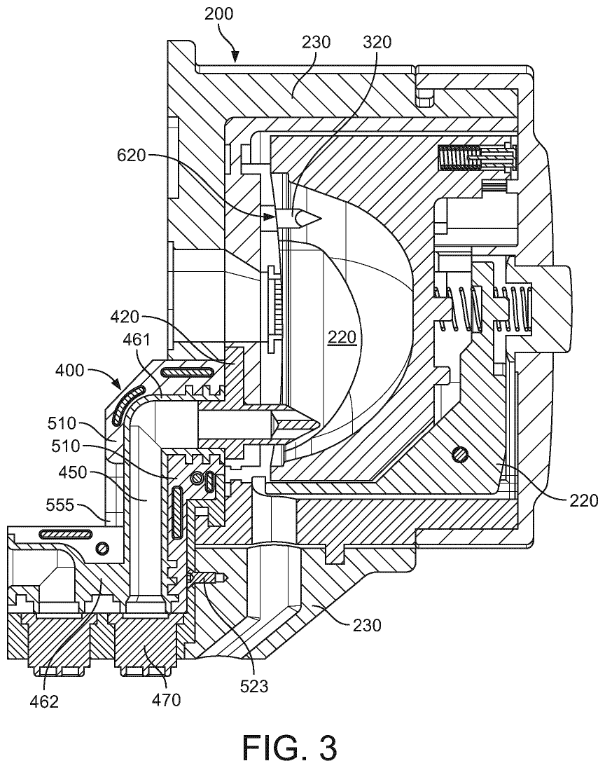

The beverage preparation machine 100 comprises a beverage production device 200. The beverage production device 200 is exemplarily illustrated in FIGS. 1 and 3.

The beverage production device 200 has a cavity 222 for receiving a beverage component to prepare a beverage upon interaction with a liquid.

The cavity 222 may be configured to receive a capsule CP via an insertion opening. Therefore, the beverage production device 200 may be provided, for example, with a hole or an empty space between two surfaces to provide the cavity 222. For example, the beverage component may be carried in the capsule CP or may be added directly into the cavity 222. The cavity 222 may have a cross-section that provides a unique orientation for the capsule CP to be inserted. In particular, the cross-section of the cavity 222 may be symmetric, asymmetric, non cylindrically symmetric and/or non cyclically symmetric. In FIG. 1, the cavity 222 is exemplarily illustrated with the capsule CP. In FIG. 3, the cavity 222 is exemplarily shown without the capsule CP.

A beverage component may be a powder (such as coffee, freeze-dried dairy products or soups), a liquid (such as syrups or aroma), fibers, leaves (such as tea leaves), and/or combinations thereof. The liquid for interacting with the beverage component may be water, milk or other fluids, including carbonated fluids or the like, preferably fluids with a low viscosity. In addition, it is also conceivable that the cavity 222 receives a cleaning product to complete a cleaning cycle of the beverage preparation machine 100.

Preferably, the beverage production device 200 may comprise a removable part 220 that comprises the cavity 222. Preferably, the removable part 220 may function as a capsule holder. For example, the removable part 220 may be the part that is filled with the beverage component and then connected to the beverage preparation machine 100. Additionally, the beverage production device 200 may comprise a receiving section 230 for functionally receiving and/or attaching the removable part 220. The configuration of the removable part 220 being received by the receiving section 230 is exemplarily illustrated in FIGS. 1 and 3. Therefore, the receiving section 230 preferably may comprise a locking structure, like a thread or a part of a bayonet lock structure, which cooperates with a locking structure of the removable part 220.

The beverage preparation machine 100 comprises a liquid delivery device 300 for delivering a liquid into the cavity 222 via a liquid inlet 320. The liquid delivery device 300 is exemplarily illustrated in FIG. 1, the liquid inlet 320 may be found in FIG. 3.

The liquid delivery device 300 may comprise a storage tank or a liquid connection to an external liquid source to allow the corresponding liquid to be provided and delivered to the cavity 222. For example, a pump 302, such as a peristaltic pump, may be used to transport the liquid. This is exemplarily illustrated in FIG. 1.

The liquid delivery device 300 may comprise the liquid inlet 320. The liquid inlet 320 may protrude into the cavity 222 and preferably taper towards the cavity 222 to form a piercing tip. For example, the liquid inlet 320 may extend into the cavity 222 in the form of a needle. The liquid inlet 320 and the water storage may be (fluidly) connected, for instance, by corresponding liquid lines 312, e.g. in the form of tubes, hoses or the like.

The beverage preparation machine 100 comprises a liquid discharge device 400 for discharging the delivered liquid, which may have already become the prepared beverage, out of the cavity 222 via a discharge outlet 420 and to a dispensing outlet 470.

The liquid discharge device 400 may comprise the discharge outlet 420. Preferably, the discharge outlet 420 may protrude into the cavity 222 and preferably taper towards the cavity 222 to form a piercing tip. The discharge outlet 420 may extend into the cavity 222 in the form of a needle. This is exemplarily illustrated in FIGS. 1 to 3.

The liquid inlet 320 may be positioned higher relatively to the discharge outlet 420 in an operational configuration of the beverage preparation machine 100. This is exemplarily illustrated in FIG. 3.

The liquid discharge device 400 may comprise the dispensing outlet 470. This is exemplarily illustrated in FIGS. 1 to 3. The dispensing outlet 470 may be configured to dispense the produced beverage product or a used sanitizing liquid out of the beverage preparation machine 100. The discharge outlet 420 and the dispensing outlet 470 may be (fluidly) connected.

The liquid discharge device 400 comprises a flexible tube 450 that is provided between the discharge outlet 420 and the dispensing outlet 470. This is exemplarily illustrated in FIGS. 1 to 3 and 5 to 7.

The flexible tube 450 may be made from a material that is suitable for food products. For example, flexible plastic materials that comply with EU directive 10/2011 or requirements set by the FDA may be used. For example, elastomers or plastic such as Polyethylene terephthalate (PET), Polyethylene (PE), Polypropylene (PP), Polycarbonate (PC) and/or Polyamide (P) may be used.

A preferable alternative is the use a of a silicone-based material (or similar) for the flexible tube 450 as it will allows the material to have a high elasticity which is preferable when the material is pinched and then comes back to its initial state.

The flexible tube 450 may at least partially extend along a longitudinal axis between two opposite end sections that may be configured to be connected to the discharge outlet 420 and the dispensing outlet 470. The flexible tube 450 may have a continuous inner surface, i.e. the inner surface does not comprise steps. The flexible tube 450 may have a constant bore diameter, which preferably may be configured to correspond with a maximum flow rate of the fluid to be dispensed. The bore diameter of the flexible tube 450 may increase along the longitudinal axis, preferably may increase from the end section for connecting the flexible tube 450 with the discharge outlet 420 towards the dispensing outlet 470.

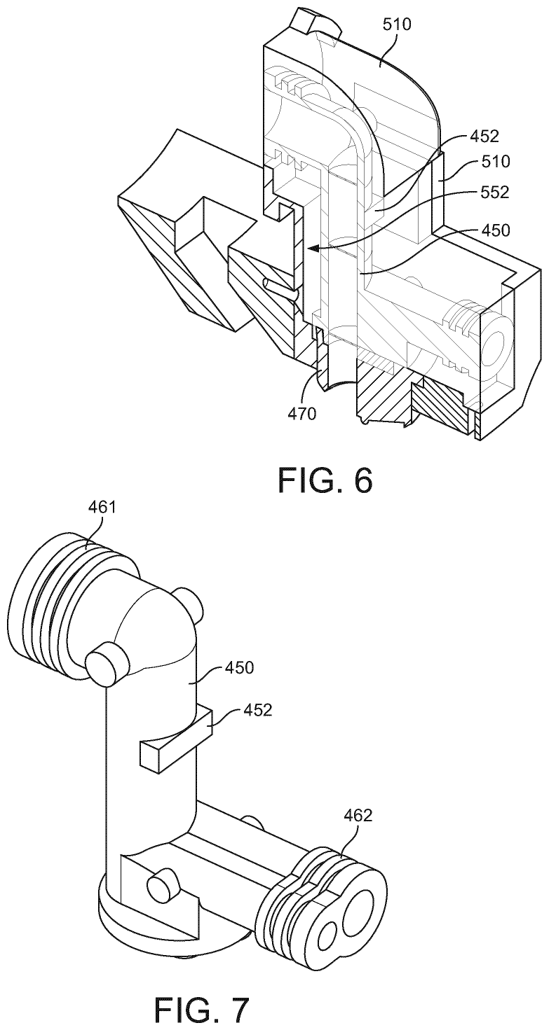

The flexible tube 450 may be detachably provided in the liquid discharge device 400. Thereby, maintenance can be simplified and improved. The flexible tube 450 may be integrally provided with tube sections 461, 462. These are exemplarily illustrated in FIG. 7. The tube sections 461, 462 may be provided with a profile that allows to provide the flexible tube 450 detachably. This is exemplarily shown in FIGS. 1 to 3. For example, the flexible tube 450 may be connected detachably with a support 510 via the tube section 461.

The flexible tube 450 may comprise an abutting section 452, which preferably may be a thickened wall section of the flexible tube 450. The functionality of this part of the flexible tube 450 will become clearer in a later part of the description. The abutting section 452 may be integrally provided with the flexible tube 450. The abutting section 452 may have any shape or form, such as a rectangular or circular shape. This is exemplarily illustrated in FIGS. 5 to 7.

The flexible tube 450 may comprise a curved portion for fluidly connecting the discharge outlet 420 with a straight portion of the flexible tube 450 as exemplarily illustrated in FIGS. 1 to 3 and 5 to 7.

The flexible tube 450 may be substantially vertical when the beverage production device 200 is in its production configuration. In this production configuration, the discharge outlet 420 may be preferably substantially horizontal. This is exemplarily illustrated in FIGS. 1 to 3.

The liquid discharge device 400 may be configured such that the dispensing outlet 470 and the flexible tube 450 can be detachably provided to the receiving section 230.

The beverage preparation machine 100 further comprises a deforming device 500. The deforming device 500 is configured to selectively deform the flexible tube 450 so as to restrict or prevent a liquid flow from the cavity 222 to the dispensing outlet 470. This is exemplarily illustrated in FIGS. 1, 2 and 4.

For example, the deforming device 500 may be configured to provide the functionality of a pinching valve. For example, the deforming device 500 may be a pinching valve that preferably may be operated via a thermal, magnetic, mechanic, pneumatic and/or hydraulic mechanism. However, this enumeration is only an example.

Preferably, the deforming device 500 may comprise the aforementioned support 510 for carrying the flexible tube 450. For example, the support 510 may be a rigid support. This is exemplarily illustrated in FIGS. 1 to 5. The support 510 may preferably be made of a metal, such as stainless steel.

The deforming device 500 may be detachably mounted on the beverage preparation machine 100. In particular, the deforming device 500 and the beverage production device 200 may be connected to each other. Preferably, the deforming device 500 may be (detachably) connected to the beverage production device 200 to form a single piece. Preferably, the support 510 may be detachably connected to the receiving section 230, for example via a screw 523.

The deforming device 500 may comprise a pinching element 550 that is moveable between a multitude of different (selectable) positions. Preferably, the pinching element 550 may be moveable in a binary, stepwise and/or continuous manner.

For example, the pinching element 550 may be a slidable pusher, preferably made of a (rigid and/or durable) material, such as plastic or metal.

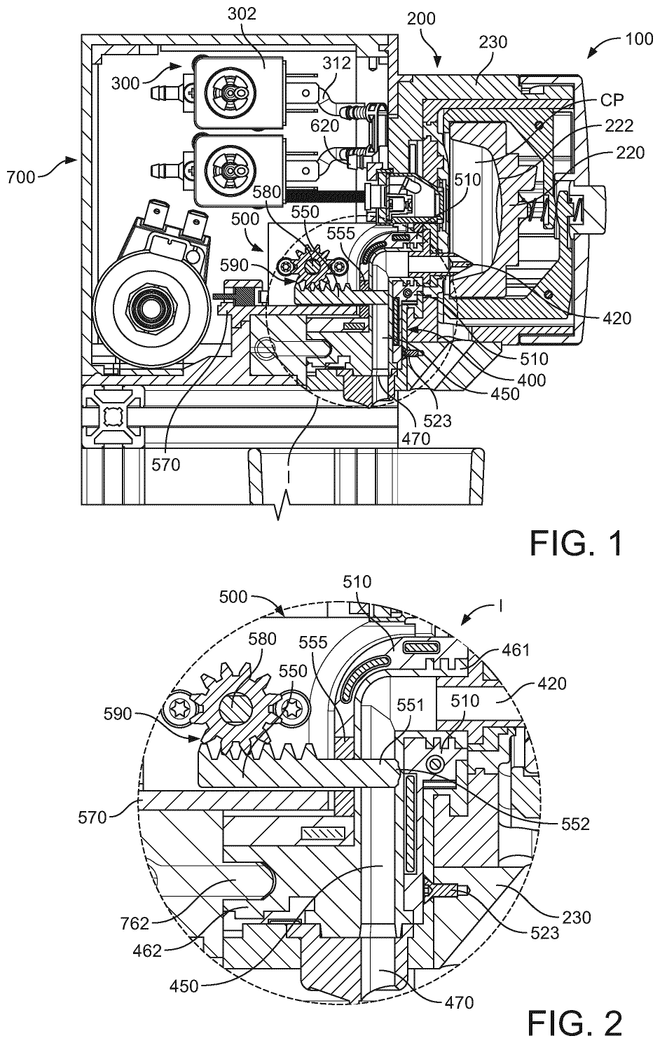

In particular, the pinching element 550 may be moveable between a first and a second position. In the first position, the pinching element 550 may deform the flexible tube 450 so as to restrict or prevent the liquid flow from the cavity 222 to the dispensing outlet 470. This is exemplarily illustrated in FIGS. 1 and 2. The liquid stream through the flexible tube 450 may be completely stopped or be at least reduced. Therefore, the bore opening of the flexible tube 450 may be reduced to an opening with a (pre-)defined area, for example to have no opening at all or only an opening with a diameter with a fraction of the bore of the flexible tube 450.

In the second position, the pinching element 550 may relax the flexible tube 450 so as to allow liquid flow, which is increased with respect to the first position, from the cavity 222 to the dispensing outlet 470. This is exemplarily illustrated in FIGS. 3, 5 and 6, whereby the full bore of the flexible tube 450 may be used for dispensing fluid through the dispensing outlet 470. However, it is also conceivable that in the second position the flexible tube 450 may be still deformed by the deforming device 500 to an extend that allows liquid to flow through a reduced diameter of the flexible tube 450. Preferably, the flow rate of a liquid flowing through the flexible tube 450 measured in the first position may be preferably significantly (at least reduced to a fraction of 10) smaller than measured in the second position by otherwise same conditions.

The pinching element 550 may comprise two pinching sections 551, 552. The pinching sections 551, 552 may be provided at opposite sides of the flexible tube 450. This is exemplarily illustrated in FIGS. 1 and 2 but particularly highlighted in FIG. 2.

At least one of the pinching sections 551, 552 may be moveable so as to selectively displace (the corresponding section of) the pinching element 550 between the first position and the second position. Thus, it is conceivable that at least two movable pinching elements 550 are provided on opposite sides of the flexible tube 450.

It is also conceivable that one of the pinching sections 551, 552 may be moveable and the other one of the pinching sections 551, 552 is fixed. The one of the pinching sections 551, 552 that is fixed may be a part of the support 510. This is exemplarily illustrated in the FIGS. 1 and 2, where the fixed pinching section 552 is exemplarily illustrated as an inner side wall of the support 510.

The support 510 may comprise an opening 555 for the pinching element 550 to move towards the flexible tube 450. This is exemplarily illustrated in FIGS. 1 to 3. The pinching element 550 may move substantially perpendicular to the longitudinal axis of the flexible tube 450 as exemplarily illustrated in FIGS. 1, 2 and 4.

As mentioned already above, the flexible tube 450 may comprise the abutting section 452, which is exemplarily illustrated in FIGS. 5 to 7. The deforming device 500 may be supported by the abutting section 452 when deforming the flexible tube 450 via the abutting section 452.

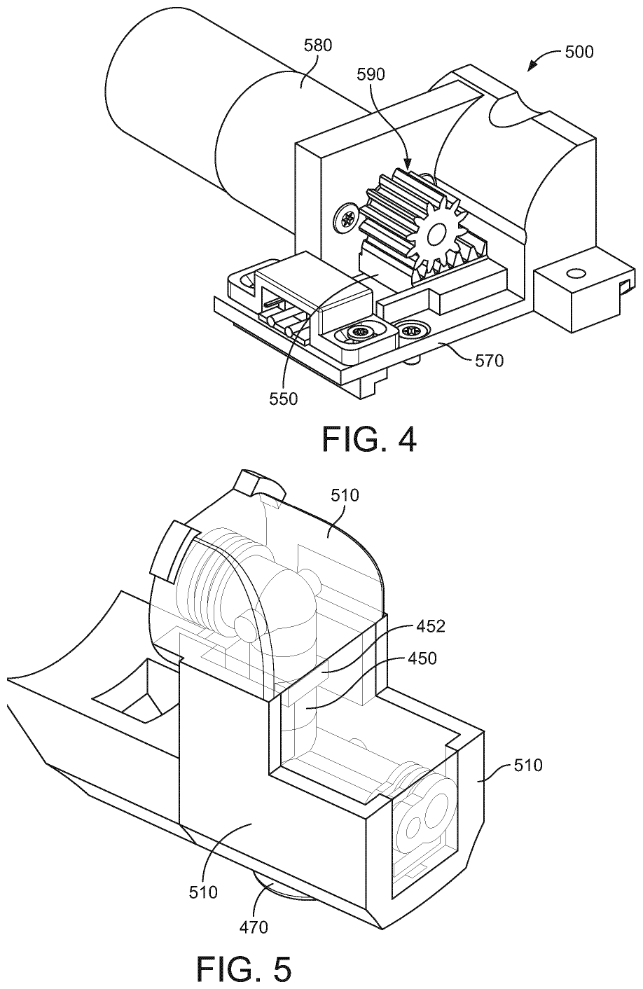

The deforming device 500 may comprise an actuator 580, like an electric motor. This is exemplarily illustrated in FIG. 4. However, this is only an example. The actuator 580 may also be a pneumatic or hydraulic piston, a linear electric motor, such as a piezo motor, or other types of actuators that are configured to provide power for a linear motion.

The actuator 580 may move the pinching element 550 between the first position and the second position. Therefore, the actuator 580 may be functionally connected to the pinching element 550. A functional connection between actuator 580 and pinching element 550 may be, for example, a gear mechanism 590. The gear mechanism 590 may comprise a circular gear as a pinion that engages with a linear gear as a rack to translate rotational motion of the actuator 580 into linear motion. Preferably, by configuring the size of the driving gear and the size of the rack, the minimal force required for a fluid to force its way through the closed flexible tube 450 in the first position may be defined.

The liquid discharge device 400 may be detachably provided to the deforming device 500. In particular, the liquid discharge device 400 may be provided detachably to the support 510.

The beverage preparation machine 100 may comprise a gas evacuation device for evacuating gas, such as air, out of the cavity 222. The gas evacuation device is not illustrated in the figures.

Preferably, the gas evacuation device may comprise a gas outlet 620, through which air can be evacuated out of the cavity. The gas outlet 620 is indicated in FIG. 3. Preferably, the gas evacuation may commence upon beverage production or liquid delivery into the cavity 222 or capsule CP. The gas outlet 620 may protrude into the cavity 222 and preferably taper towards the cavity 222 to form a piercing tip. The gas outlet 620 and the liquid inlet 320 may be positioned higher than the discharge outlet 420. This is exemplarily illustrated in FIG. 3.

The beverage preparation machine 100 may further comprise a main body 700 that carries the beverage production device 200, the liquid delivery device 300, the liquid discharge device 400, the deforming device 500, and the gas evacuation device. This is exemplarily illustrated in FIG. 1.

The deforming device 500 may comprise a connection section, by which the deforming device 500 may be (detachably) connected to the main body 700.

For example, platform 570 may connect the deforming device 500 via a screw connection to the beverage preparation machine 100 as illustrated in FIGS. 1 to 3.

Additionally or alternatively, the tube section 462 may function as a connection section by attaching to at least one centring pin 762 provided in the main body 700. This is exemplarily illustrated in FIGS. 1 and 2. FIG. 7 shows exemplarily that the tube section 462 may be provided with two lateral openings that may be used for this purpose.

Alternatively or additionally, at least a part of the connection section may be integrally formed with the flexible tube 450. Alternatively or additionally, at least a part of the connection section may be integrally formed with the support 510.

A further aspect of the invention relates to a method for delivering a liquid through a beverage preparation device such as the beverage preparation machine 100 described hereinbefore.

In a first step, the beverage preparation machine 100 according to the present invention is provided.

In an optional step, a beverage component in the cavity 222 of the beverage production device 200 may be provided. For example, the beverage component can be carried inside the capsule CP. This may be done in case of the beverage preparation machine 100 being used for preparing a food product, such as a beverage. However, if the beverage preparation machine 100 is intended to be sanitized by a sanitizing liquid, like hot water, it may be omitted to insert the capsule CP into the cavity 222 of the removable part 220, unless, the capsule CP carries a sanitizing component like a softening agent. However, this is only an exemplary enumeration.

Optionally, the flexible tube 450 may be released to dispense a liquid for flushing the flexible tube 450 and the dispensing outlet 470 before starting the beverage preparation process.

Subsequently, the flexible tube 450 is deformed by the deforming device 500.

Then, liquid is delivered by the liquid delivery device 300 into the cavity 222 via the liquid inlet 320.

Optionally, the deformation of the flexible tube 450 may be held for a predetermined time, that may, for example, correspond with a required infusion or preparation time of the beverage or food product that is requested.

Optionally, gas, like air, is evacuated out of the cavity 222 or, if present, out of the capsule CP upon or during delivery of the liquid or beverage production.

Afterwards, the flexible tube 450 is released by the deforming device 500 so as to discharge the delivered liquid out of the cavity 222 via the discharge outlet 420 and then to the dispensing outlet 470 of the liquid discharge device 400.

Optionally, a liquid, like water for beverage production or a sanitizing liquid, is delivered into the cavity 222 or, if present, into the capsule CP within the cavity 222, via the liquid delivery device 300, preferably at the end of the beverage preparation process.

The invention is not limited by the embodiments as described hereinabove, as long as being covered by the appended claims. All the features of the embodiments described hereinabove can be combined in any possible way and be provided interchangeably.

1. Beverage preparation machine comprising:
a beverage production device having a cavity for receiving a beverage component to prepare a beverage upon interaction with a liquid,
a liquid delivery device for delivering a liquid into the cavity via a liquid inlet,
a liquid discharge device for discharging the delivered liquid, preferably the prepared beverage, out of the cavity via a discharge outlet and to a dispensing outlet,
wherein the liquid discharge device comprises a flexible tube provided between the discharge outlet and the dispensing outlet, and
wherein the beverage preparation machine further comprises
a deforming device configured to selectively deform the flexible tube so as to restrict or prevent a liquid flow from the cavity to the dispensing outlet.

2. Beverage preparation machine according to claim 1, wherein the deforming device comprises a support for carrying the flexible tube.

3. Beverage preparation machine according to claim 1, wherein the deforming device comprises a pinching element being moveable between a first position in which the pinching element deforms the flexible tube so as to restrict or prevent the liquid flow from the cavity to the dispensing outlet, and a second position in which the pinching element relaxes the flexible tube so as to allow increased liquid flow from the cavity to the dispensing outlet with respect to the first position.

4. Beverage preparation machine according to claim 3, wherein the pinching element comprises two pinching sections, wherein at least one of the pinching sections is moveable so as to selectively displace the pinching element between the first position and the second position.

5. Beverage preparation machine according to claim 4, wherein one of the pinching sections is moveable and the other one of the pinching sections is fixed, the latter being preferably a part of the support like an inner side wall.

6. Beverage preparation machine according to claim 1, wherein the flexible tube comprises an abutting section, preferably a thickened wall section of the flexible tube, for supporting the deforming device upon deformation action.

7. Beverage preparation machine according to claim 1, wherein the deforming device further comprises an actuator, like an electric motor, for actuating the deforming device.

8. Beverage preparation machine according to claim 1, further comprising a gas evacuation device for evacuating gas, like air, out of the cavity, via a gas outlet.

9. Beverage preparation machine according to claim 1, wherein the liquid inlet protrude into the cavity.

10. Beverage preparation machine according to claim 1, wherein the beverage production device comprises a removable part comprising the cavity and a receiving section for functionally receiving the removable part.

11. Beverage preparation machine according to claim 1, wherein the cavity is configured to receive a capsule carrying a beverage component to interact with a liquid delivered into the cavity by the liquid delivery device.

12. Beverage preparation machine according to claim 1, further comprising a main body carrying the beverage production device, the liquid delivery device, the liquid discharge device, and the deforming device.

13. Beverage preparation machine according to claim 1, wherein the deforming device is detachably mounted.

14. Beverage preparation machine according to claim 1, wherein the flexible tube is substantially vertical when the beverage production device is in its production configuration, the discharge outlet being substantially horizontal.

15. Method for delivering a liquid through a beverage preparation machine, comprising the steps of:
providing a beverage preparation machine,
receiving a beverage component in a cavity of the beverage production device, the beverage component being for example carried in a capsule,
deforming a flexible tube by a deforming device,
delivering a liquid by the liquid delivery device into the cavity via the liquid inlet, while halting the deformation for a predetermined time, and
releasing the flexible tube by the deforming device so as to discharge the delivered liquid out of the cavity via a discharge outlet to a dispensing outlet of the liquid discharge device.
